(19) United States
(12) Patent Application Publication
(10) Pub. No.: US 2015/0212662 A1
(43) Pub. Date: Jul. 30, 2015

(54) DROPDOWN MODE COMMAND BUTTON

(71) Applicants: Manoharan G. Earurnthavadi, Bangalore (IN); Robert Dean Vavra, Roseville, MN (US); Jarrett K. Bly, Minneapolis, MN (US); Penny L. Svenkeson, Roseville, MN (US); Kumar Atul, Bangalore (IN)

(72) Inventors: Manoharan G. Earurnthavadi, Bangalore (IN); Robert Dean Vavra, Roseville, MN (US); Jarrett K. Bly, Minneapolis, MN (US); Penny L. Svenkeson, Roseville, MN (US); Kumar Atul, Bangalore (IN)

(73) Assignee: UNISYS CORPORATION, Blue Bell, PA (US)

(21) Appl. No.: 14/168,116

(22) Filed: Jan. 30, 2014

(51) Int. Cl. G06F 3/0482

(52) U.S. Cl. CPC G06F 3/0482

(57) ABSTRACT

Systems and methods are disclosed herein to a method for presenting a user interface comprising: presenting a user interface with at least one standard command button and an advanced button adjacent to the at least one standard command button; receiving a first selection; performing a standard command associated with the at least one standard command button when the received first selection selects the at least one standard command button; displaying at least one advanced command button above the advanced button when the received first selection selects the advanced button; receiving a second selection; and performing an advanced command associated with the at least one advanced command button when the received second selection selects the at least one advanced command button.

### TECHNICAL FIELD

The present invention relates generally to user interfaces, and more particularly to a method of presenting function buttons in a user interface.

### BACKGROUND

Graphical user interfaces (GUI) are common ways in which a computer system presents options and information and receives commands. Before GUIs, computer systems were commanded using low-level computer language or command-line parameters and commands. Low-level computer languages and command-line commands essentially required a user to learn a new language: the language understood by the computer. GUIs have replaced command lines to make computers more user-friendly, and most computer applications include a GUI. Due to the advancement of GUIs, a typical user does not need to understand computer language or DOS commands to command a computer because the buttons and menus of GUIs have replaced command-line for commanding the computer. Also, because the menus and buttons use plain language, a user can easily ascertain what functions the buttons or menu items will perform.

Generally, GUIs receive commands from a user when a user activates a button or menu item, and the GUI transforms the activation of the button or menu item into machine-understood commands. The machine-understood commands are performed in the background. So, GUIs streamline computer commands to make computers more user-friendly and efficient.

While GUIs are extremely important to the operation of a computer, a computer screen only has so much real estate for buttons and menus. In general, computer applications have many functions and understand many commands. So, in order to present all of those functions and commands in a graphical format, many buttons may need to appear on the screen. As the number of buttons on the screen increases, the GUI may begin to feel cluttered. A cluttered interface may be annoying to a user or make the GUI feel less user-friendly. Thus, there is a need to present multiple buttons without cluttering the screen in a GUI.

### SUMMARY

The systems and methods described herein attempt to overcome the drawbacks discussed above by displaying an advanced button in a user interface that displays advanced command buttons upon the activation of the advanced button. As a result, the user interface is less cluttered with function buttons, and the user interface is more user friendly.

In one embodiment, a method for presenting a user interface comprises: presenting, by a computer, a user interface with at least one standard command button and an advanced button adjacent to the at least one standard command button; receiving, by a computer, a first selection from a user; performing, by a computer, a standard command associated with the at least one standard command button when the received first selection selects the at least one standard command button, wherein the standard command is related to power management of a computer system; displaying, by a computer, at least one advanced command button above the advanced button when the received first selection selects the advanced button; receiving, by a computer, a second selection from the user, and performing, by a computer, an advanced command associated with the at least one advanced command button when the received second selection selects the at least one advanced command button, wherein the advanced command is related to power management of the computer system.

In another embodiment, a method of presenting a user interface comprises: presenting, by a computer, a user interface with at least one standard command button and an advanced button adjacent to the at least one standard command button; receiving, by a computer, a first selection from a user; performing, by a computer, a standard command associated with the at least one standard command button when the received first selection selects the at least one standard command button, wherein the standard command is related to partition management of a computer system: displaying, by a computer, at least one advanced command button above the advanced button when the received first selection selects the advanced button; and receiving, by a computer, a second selection from the user; performing, by a computer, an advanced command associated with the at least one advanced command button when the received second selection selects the at least one advanced command button, wherein the advanced command is related to partition management of the computer system.

In another embodiment, a computer program product, comprising a computer-usable medium, having a computer readable program code embodied therein, said computer readable program code adapted to be executed by a processor to implement a method for presenting a user interface, the method comprises: providing the user interface, wherein the user interface comprises distinct software modules, and wherein the distinct software modules comprise a first button module, a second button module, and an advanced button module; upon selection of a first button in the user interface, performing a first command, wherein the first command is performed by the first button module, and wherein the first command is related to partition management of a computer system; upon selection of a second button in the user interface, performing a second command, wherein the second command is performed by the second button module, and wherein the second command is related to power management of the computer system or a partition of the computer system; upon selection of an advanced button in the user interface, activating a first advanced command button module and a second advanced command button module, wherein the activation of the first and second advanced command button modules is performed by the advanced button module; upon the activation of the first and second advanced command button modules, displaying a first advanced command button and a second advanced command button in the user interface above the advanced button, wherein displaying the first and second advanced command buttons is performed by the advanced button module; upon a selection of the first advanced command button in the user interface, performing a third command, wherein the third command is performed by the first advanced command button module, and wherein the third command is related to power or partition management of the computer system; and upon a selection of the second advanced command button in the user interface, performing a fourth command, wherein the fourth command is performed by the second advanced command button module, and wherein the fourth command is related to power or partition management of the computer system.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 illustrates a computer system for presenting a user interface that includes at least one standard command button and an advanced button adjacent to the at least one standard command button to a client device according to an exemplary embodiment.

FIG. 2 illustrates a screen shot of a collapsed advanced command button according to an exemplary embodiment.

FIG. 3 illustrates a screen shot of an expanded advanced command button for power management according to an exemplary embodiment.

FIG. 4 illustrates a screen shot of an expanded advanced command button for partition management according to an exemplary embodiment.

FIG. 5 illustrates a flow chart for presenting the advanced command button on a user interface according to an exemplary embodiment.

### DETAILED DESCRIPTION

Reference will now be made in detail to the preferred embodiments, examples of which are illustrated in the accompanying drawings.

The embodiments described above are intended to be exemplary. One skilled in the art recognizes that numerous alternative components and embodiments may be substituted for the particular examples described herein and still fall within the scope of the invention.

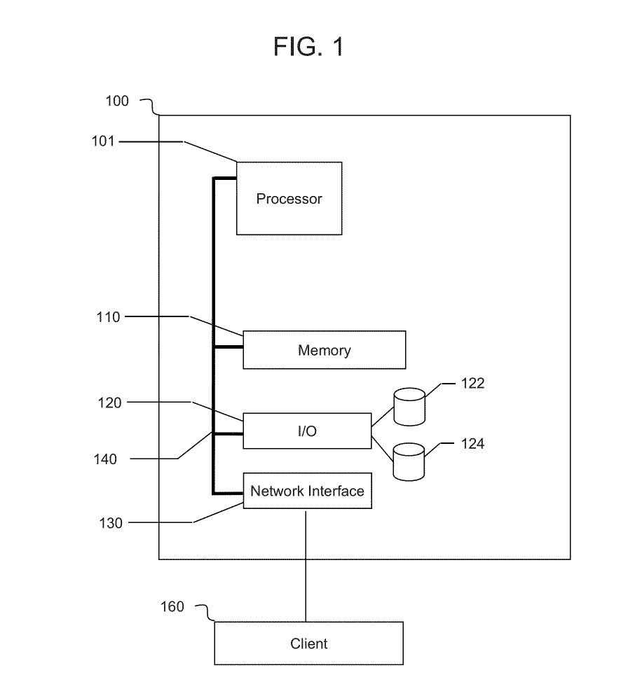

Referring to FIG. 1, a computer system 100 may include a processor 101, a memory 110, an input/output (I/O) interface 120, a network interface 130, and a data bus 140. The processor 101, the memory 110, the I/O interface 120, the network interface 130 may all communicate with one another through the data bus 140. While the elements listed above are illustrated in FIG. 1, it is to be understood that the computer system 100 may include many more computing components, such as a graphics module, a hard drive, a CD-ROM drive, DVD-ROM drive, tape drive, audio modules, universal serial bus (USB) ports, power supplies, cooling devices, heat sinks, or any other components that may be included in a computing device. The size and configuration of the computing system 100 may increase or decrease depending on computing model or customer need.

The processor 101 may be embodied by one or more processors if the computer system 100 is a multi-processor system. If the computer system has multiple processors, each processor may perform a different task, and each processor may be differently configured to accommodate their specific tasks. Alternatively, all of the processors may be constructed in the same manner, and one or more of the processors may be a spare processor included for redundancy. Additionally, one or more of the processors may be included to provide supervisory control over the other processors.

The memory 110 may include any computer storage medium, either volatile or non-volatile, removable or non-removable, such as FLASH, RAM, ROM, EEPROM, or any other storage medium that is configured to store information in any method or technology for information storage. The memory 110 is configured to store computer readable information, such as computer readable instructions and data. The memory 110 may be implemented to store program code to direct the processor 101 to process information and requests to or from other computing systems connected to the computer system 100 in any manner, such as through the network interface 130. The memory 110 may also be implemented to store program code to direct the processor 101 and the I/O interface 120 to present a user interface to a user.

The network interface 130 provides a network connection means and network protocols useful for sending and receiving information from and to other computer systems connected to the computer system 100. The network interface 130 may be connected to a network of any type, such as a local area network (LAN), a wide area network (WAN), or a wireless local area network (WLAN). The network interface 130 may communicate with other computer systems, such as a client computer 160, on the network through network protocols, such as TCP/IP, FTP, SSH, or any other network protocol. In addition, the network interface 130 may be connected to a network through any means including wireless means, such as Bluetooth, IEEE 802.11, and infrared, or wired means, such as Ethernet, firewire, and coaxial.

Peripheral devices 122 and 124 are connected to the I/O interface 120, and the peripheral devices 122 and 124 allow the computer system 100 to receive inputs from a user and output data and information to the user. The computer system 100 may include more or less than two peripheral devices. The peripheral devices 122 and 124 may include a mouse, a keyboard, a monitor, a printer, a scanner, a touch screen, buttons, or any other peripheral device useful for receiving data from a user and outputting data to a user. In the following example, the first peripheral device 122 is a display, and the second peripheral device 124 is a mouse. An operator of the computer system 100 may configure the computer system 100 using the peripheral devices 122, 124. Alternatively, the client computer 160 that is connected to the computer system 100 may configure the computer system 100. The client computer 160 may connect to the computer system 100 over a communications network through the network interface 130.

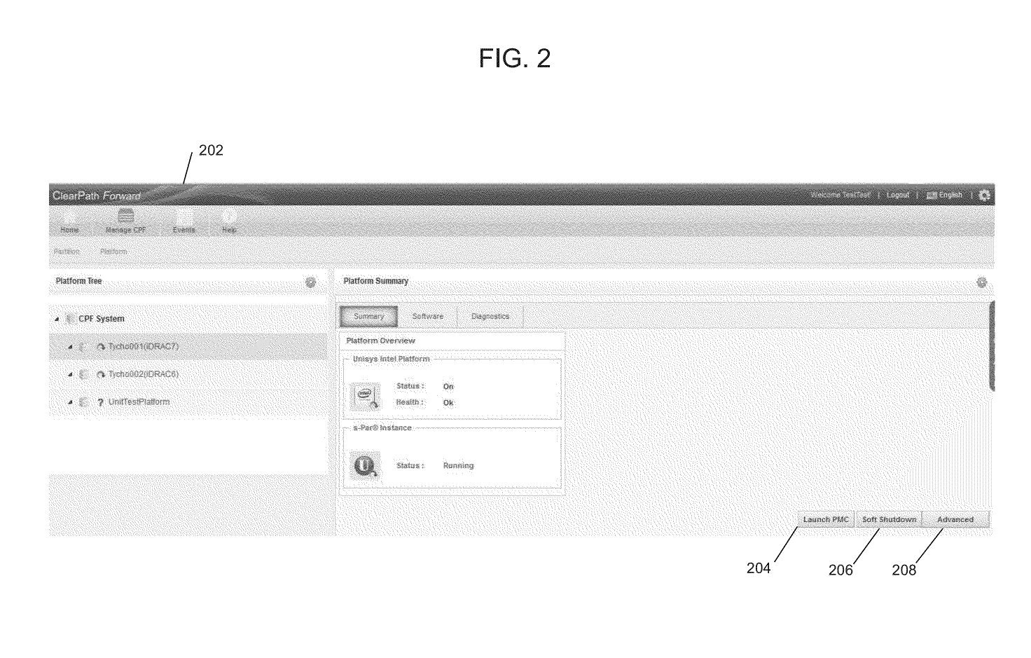

An operator may manage settings, configurations, or applications of the computer system 100 through a user interface. An exemplary computer system user interface is illustrated in FIGS. 2-4. An operator may also view status updates of the computer system 100 or control operations and processes of the computer system 100 using the user interface. For example, the user interface may be a web interface displayed on the client computer 160, and an operator may change settings or view information about the computer system 100 by connecting to the computer system 100 remotely. The user interface may have a plurality of different buttons and information presented. Some buttons may be more frequently used than others. For example, the computer system may have seven different types of power management commands or options, and two of the options are standard power management selections, and the remaining five options are advanced power options, which may be less frequently used. Always presenting seven different buttons for the seven different options on a computer screen may clutter the user interface.

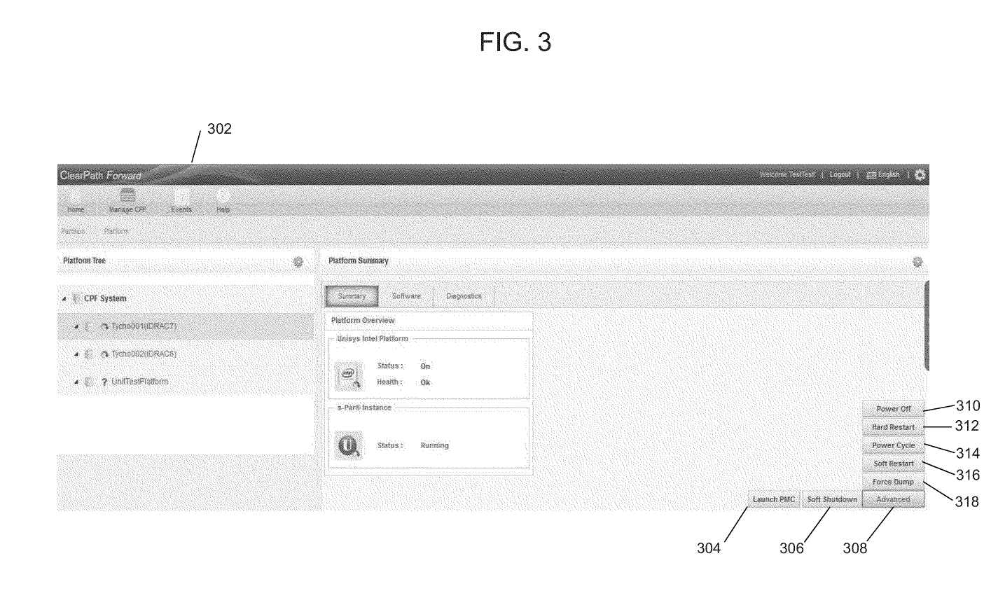

Rather than always displaying the standard options and the advanced options on the user interface, the user interface of the exemplary embodiments, gathers all of the advanced options into an expandable advanced button. Upon activation of the advanced button, the five advanced options expand from the advanced button, and the user interface displays five more buttons. This functionality is illustrated in FIGS. 2-3.

As shown in FIG. 2, the computer system displays a user interface 202 to a user. Included in the user interface are three power management buttons: two standard buttons (a Launch PMC button 204, a soft shutdown button 206), and an Advanced button 208. The launch PMC 204 button may be used to launch a web interface. The power management buttons perform power management functions, but the buttons of the exemplary embodiments may be applied to any type of computer command or function. Also, while two standard buttons 204, 206 are displayed next to the Advanced button 208, the computer system may present more or less than two standard buttons. Regardless of the configuration, the exemplary embodiments always include the Advanced button 208. The computer system may display the Advanced button 208 adjacent to the standard buttons 204, 206.

Clicking on either of the standard buttons 204, 206 results in the computer system performing the function or command assigned to the activated standard button 204 or 206. In one example, clicking the soft shutdown 204 executes a command to perform a normal shut down operation of the entire computer system.

When a user activates the Advanced button 208, additional buttons appear, as shown in FIG. 3. Referring now to FIG. 3, five advanced command buttons 310, 312, 314, 316, 318 appear above the Advanced button 308 within the user interface 302. The advanced command buttons 310, 312, 314, 316, 318 may pop up or slide out from the Advanced button 308. How the advanced command buttons 310, 312, 314, 316, 318 slide out, pop up, or otherwise extend from the Advanced button 308 is a matter of designer choice in user interface ornamental appearance. Similar to activation of the standard buttons 304, 306, activation of any of the advanced command 310, 312, 314, 316, 318 results in the computer system performing the function or command assigned to the user activated advanced command button 310, 312, 314, 316, 318. For example, clicking the soft restart button 316 executes a command to reboot the entire computer system without interrupting the power supplied to the computer system. The remaining advanced command buttons 310, 312, 314, 318 may be a power off button 310, a hard reset button 312, a power cycle button 314, and force dump button 318.

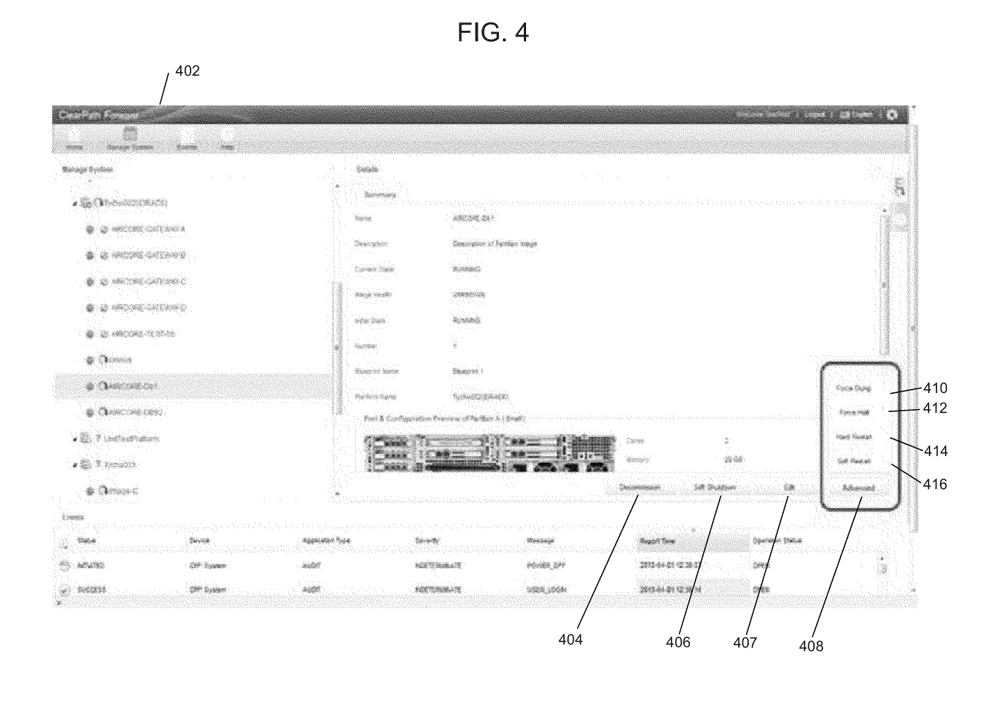

As discussed above, the advanced button may be applied to computer system functions other than power management. FIG. 4 illustrates that the Advanced button 408 can be applied to a partition management user interface 402 as well. Referring now to FIG. 4, the user interface 402 includes three standard buttons 404, 406, 407 and the advanced button 408. FIG. 4 illustrates that the advanced button 408 has been activated by a user, and four advanced command buttons 410, 412, 414, 416. The number of buttons is different in this embodiment because the functions of the buttons in FIG. 4 are applied to partition management rather than power management. For example, the hard reset button 416 executes a command to reboot the selected partition. The remaining advanced command buttons 410, 412, 414 may include a force dump button 410, a force halt 412, and a soft reset button 414. The standard buttons include a decommission button 404 that decommissions the selected partition image, a soft shutdown button 406 that shuts down the selected partition image, and an edit button 407 that edits the partition image's attributes.

As illustrated by the contrast between FIG. 3 and FIG. 4, the advanced button 308, 408 may be context sensitive. In FIG. 3, the advanced button 308 presented five advanced command buttons 310, 312, 314, 316, 318 for power management of the entire system, whereas the advanced button 408 of FIG. 4 presented four advanced command buttons 410, 412, 414, 416 for partition management. So, the advanced button 308, 408 changes the number of advanced command buttons and which advanced command buttons to display depending on the current view or page of the user interface or a context of the functions performed by the user.

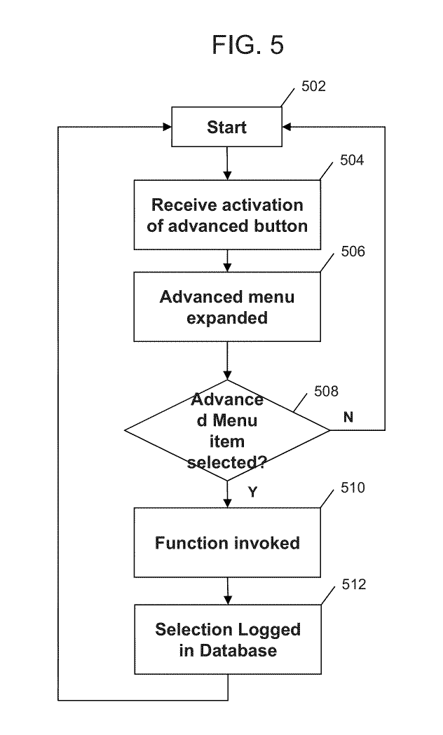

FIG. 5 illustrates a flow chart of the advanced button. As shown in FIG. 5, the flow begins at step 502 and the computer system waits for a user to activate the advanced button. In step 504, the computer system receives an activation of the advanced button by the user. Activation of the advanced button may be performed by selecting the advanced button (mouse click or touch), moving a mouse cursor over the advanced button, or receiving a keyboard shortcut command, or any other method of user interface button selection. Upon receiving the activation of the advanced button, the computer system expands the advanced menu and displays the advanced command buttons associated with the advanced button in step 506. As described above, the advanced command buttons displayed may depend on the context of the user interface, so the computer system may first need to determine which advanced command buttons to display by referencing the memory of the computer. After expanding the advanced button menu, the computer system waits until a user performs an action and determines if the user has selected one of the advanced menu buttons in step 508. If no advanced command button is selected, the flow returns to step 502. For example, the computer system may display the advanced menu for a predetermined period of time before hiding the advanced menu again. If the advanced menu appears when a mouse cursor scrolls over the advanced button, the advanced menu may hide when the mouse cursor is no longer scrolling over the advanced button or the advanced menu. If a user has selected one of the advanced command buttons, the computer system invokes the selected function in step 510 and logs the selection in a database in step 512. The selection is logged into the database for internal auditing purposes. The information contained in the database describes which user performed which action. The time at which the command was performed may also be logged in the database.

According to the exemplary embodiments described herein, the advanced button produces advanced command buttons upon the activation of the advanced button. The user interface displays the advanced command buttons after activation of the advanced button, and so, the user interface is less cluttered with function buttons, and the user interface is more user friendly.

The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, those skilled in the art will appreciate that one or more acts described herein may be performed by hardware, software, or a combination thereof, as may be embodied in one or more computing systems.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “displaying” or “receiving” or “referencing” or “changing” or “refreshing” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that numerous alternative components and embodiments that may be substituted for the particular examples described herein and still fall within the scope of the invention.

What is claimed is:

1. A method for presenting a user interface comprising:
presenting, by a computer, a user interface with at least one standard command button and an advanced button adjacent to the at least one standard command button:
receiving, by a computer, a first selection from a user;
performing, by a computer, a standard command associated with the at least one standard command button when the received first selection selects the at least one standard command button, wherein the standard command is related to power management of a computer system;
displaying, by a computer, at least one advanced command button above the advanced button when the received first selection selects the advanced button;
receiving, by a computer, a second selection from the user; and
performing, by a computer, an advanced command associated with the at least one advanced command button when the received second selection selects the at least one advanced command button, wherein the advanced command is related to power management of the computer system.

2. The method of claim 1, wherein the first and second selections are received from a peripheral device through an input/output interface of the computer.

3. The method of claim 1, wherein the first and second selections are received from a remote computing device connected to the computer through a communication network.

4. The method of claim 1, further comprising:
logging, by a computer, the second selection in a database after receiving the second selection.

5. The method of claim 4, wherein the logged second selection includes which user made the second selection and which command was selected.

6. The method of claim 5, wherein the logged second selection further includes a time when the second selection was received.

7. The method of claim 1, further comprising:
hiding, by a computer, the at least one advanced command button if the second selection of the at least one advanced command button is not received within a predetermined time.

8. The method 1, wherein the at least one advanced command button includes a power off button, a hard restart button, a power cycle button, a soft restart button, and a force dump button.

9. A method for presenting a user interface comprising:
presenting, by a computer, a user interface with at least one standard command button and an advanced button adjacent to the at least one standard command button;
receiving, by a computer, a first selection from a user,
performing, by a computer, a standard command associated with the at least one standard command button when the received first selection selects the at least one standard command button, wherein the standard command is related to partition management of a computer system;
displaying, by a computer, at least one advanced command button above the advanced button when the received first selection selects the advanced button;
receiving, by a computer, a second selection from the user; and
performing, by a computer, an advanced command associated with the at least one advanced command button when the received second selection selects the at least one advanced command button, wherein the advanced command is related to partition management of the computer system.

10. The method of claim 9, wherein the first and second selections are received from a peripheral device through an input/output interface of the computer.

11. The method of claim 9, wherein the first and second selections are received from a remote computing device connected to the computer through a communication network.

12. The method of claim 9, further comprising:
logging, by a computer, the second selection in a database after receiving the second selection.

13. The method of claim 12, wherein the logged second selection includes which user made the second selection and which command was selected.

14. The method of claim 13, wherein the logged second selection further includes a time when the second selection was received.

15. The method of claim 9, further comprising:
hiding, by a computer, the at least one advanced command button if the second selection of the at least one advanced command button is not received within a predetermined time.

16. The method of 9, wherein the at least one advanced command button includes a force dump button, a hard restart button, a soft restart button, and a force halt button.

17. The method of claim 9, wherein the at least one standard command button includes a decommission button, a soft shutdown button, and an edit button.

18. A computer program product, comprising a computer-usable medium, having a computer readable program code embodied therein, said computer readable program code adapted to be executed by a processor to implement a method for presenting a user interface, the method comprising:
providing the user interface, wherein the user interface comprises distinct software modules, and wherein the distinct software modules comprise a first button module, a second button module, and an advanced button module;
upon selection of a first button in the user interface, performing a first command, wherein the first command is performed by the first button module, and wherein the first command is related to partition management of a computer system;
upon selection of a second button in the user interface, performing a second command, wherein the second command is performed by the second button module, and wherein the second command is related to power management of the computer system or a partition of the computer system;
upon selection of an advanced button in the user interface, activating a first advanced command button module and a second advanced command button module, wherein the activation of the first and second advanced command button modules is performed by the advanced button module;
upon the activation of the first and second advanced command button modules, displaying a first advanced command button and a second advanced command button in the user interface above the advanced button, wherein displaying the first and second advanced command buttons is performed by the advanced button module;
upon a selection of the first advanced command button in the user interface, performing a third command, wherein the third command is performed by the first advanced command button module, and wherein the third command is related to power or partition management of the computer system; and
upon a selection of the second advanced command button in the user interface, performing a fourth command, wherein the fourth command is performed by the second advanced command button module, and wherein the fourth command is related to power or partition management of the computer system.
